(19) United States
(12) Patent Application Publication
(10) Pub. No.: US 2015/0093942 A1
(43) Pub. Date: Apr. 2, 2015

(54) STRUCTURE OF CONNECTOR COMBINATION

(71) Applicant: KINNEXA, INC., Taipei City (TW)

(72) Inventor: KUAN-HSIUNG WEI, Taipei City (TW)

(73) Assignee: KINNEXA, INC., Taipei City (TW)

(21) Appl. No.: 14/043,858

(22) Filed: Oct. 2, 2013

(51) Int. Cl. H01R 13/514

(52) U.S. Cl. CPC H01R 13/514
USPC 439/701

(57) ABSTRACT

A structure of a connector combination includes at least one first RJ45 connector, a second RJ45 connector, and a positioning member. The first RJ45 connector has at least one side forming a first coupling section. The second RJ45 connector has at least one side forming a second coupling section that is jointable to the first coupling section. As such, the first RJ45 connectors and the second RJ45 connectors can be combined with each other through the first coupling sections and the second coupling sections thereof according to a desired number of connectors, so that saving of mold cost can be achieved in respect of quantity. On the other hand, individual replacement of a broken connector is possible in a maintenance operation so as to achieve advantages of efficient maintenance and reducing maintenance-related cost.

### TECHNICAL FIELD OF THE INVENTION

The present invention generally relates to a structure of a connector combination, and more particularly to a structure of a connector combination that is advantageous in reducing mold expense and achieving efficient operations of maintenance and repairing.

### DESCRIPTION OF THE PRIOR ART

Electrical connection devices that comprise multiple receptacles, such as various hubs, generally comprise a housing in which the receptacles are formed. The housing is often made as a shielding enclosure. In manufacturing such a housing, different molds are required for those having different number of receptacles. Thus, the manufacturing expense is increased. In addition, the spacing members formed in the housing would increase the overall length thereof.

Further, the receptacles each need an additional metal casing to enclose an insulation body. The metal casing is provided for shielding electromagnetic waves or grounding. Since the receptacles are isolated from each other in the arrangement thereof in the housing, the receptacles must be individually treated for grounding. In addition, each insulation body has at least four sides to be enclosed and this increases the material cost.

Developments have been conducted for combining connectors together, wherein the primary construction is such that a housing is manufactured with an already available mold such that the housing is provided with coupling members and jointing members to carry out a combination operation. However, in such a known structure of connector, metal pieces and receptacles are arranged inside a housing, whereby when the connector gets broken, the coupling members and the jointing members of the combination must be removed first. This is a tedious and complicated operation. Further, the entire connector product must be disposed if one or more of the receptacles of the connector product get broken. This certainly increases the cost.

Thus, it is a challenge of the present inventor and the manufacturers of the industry to overcome the drawbacks and shortcomings discussed above.

### SUMMARY OF THE INVENTION

In view of the above-discussed drawbacks and shortcomings, the present invention provides a structure of a connector combination that is advantageous in reducing mold expense and achieving efficient operations of maintenance and repairing.

The primary object of the present invention is to achieve the advantages of efficient maintenance and reducing maintenance-related cost through a combination and collaborative arrangement of a positioning member and first and second coupling sections. The present invention also allows a combination to be formed according to the number of connector desired by a customer so as to save the cost of making molds.

To achieve the above object, the present invention provides a structure of a connector combination, which generally comprises at least one first RJ45 connector, a second RJ45 connector, and a positioning member, wherein the first RJ45 connector has at least one forming a first coupling section and the second RJ45 connector has at least one forming a second coupling section jointable to the first coupling section and the positioning member comprises a bar comprising slide channels formed therein, at least one fixing section formed at one end of the bar, and a fastening section set at the end opposite to the fixing section.

With the above-described structure and arrangement, to use, according to the number of connectors desired by a customer, the first RJ45 connectors and the second RJ45 connectors can be jointed and combined through the first coupling section and the second coupling section by the positioning member so that individual replacement of a broken connector is allowed in a maintenance operation to thereby achieve efficient maintenance and effective reduction of the expense of replacement.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a preferred embodiment of the present invention.

FIG. 2 is an exploded view of the preferred embodiment of the present invention.

FIG. 3 is a partial schematic view of the preferred embodiment of the present invention.

FIG. 4 is a perspective view showing an example of using the preferred embodiment of the present invention.

FIG. 5 is a perspective view showing an example of using another preferred embodiment of the present invention.

FIG. 6 is a perspective view showing an example of using a further preferred embodiment of the present invention.

FIG. 7 is a perspective view showing another example of using said further preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

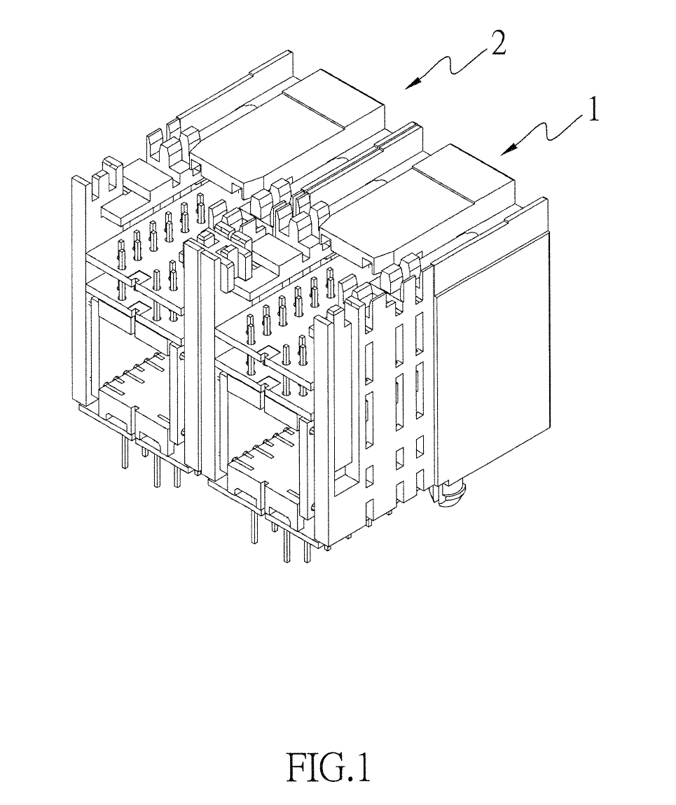

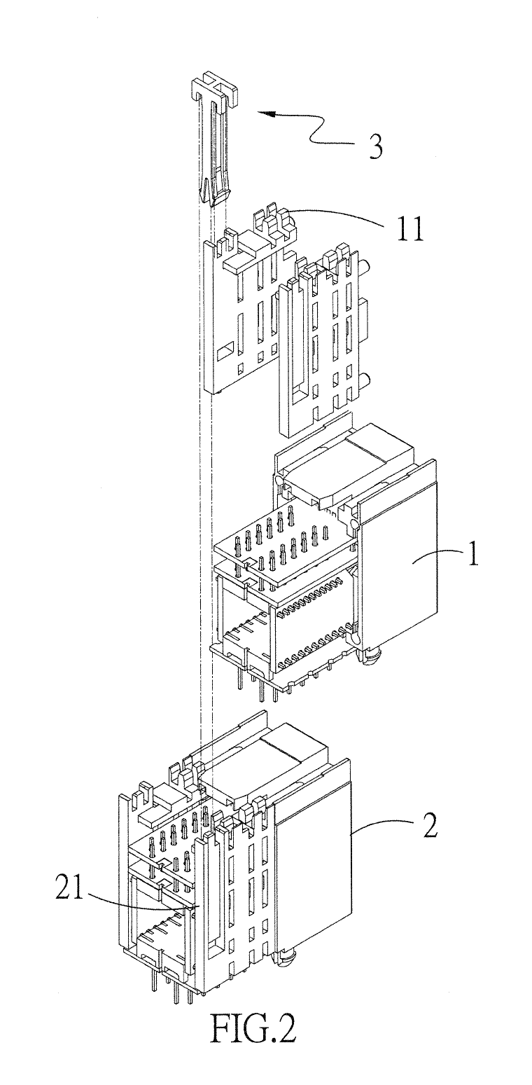

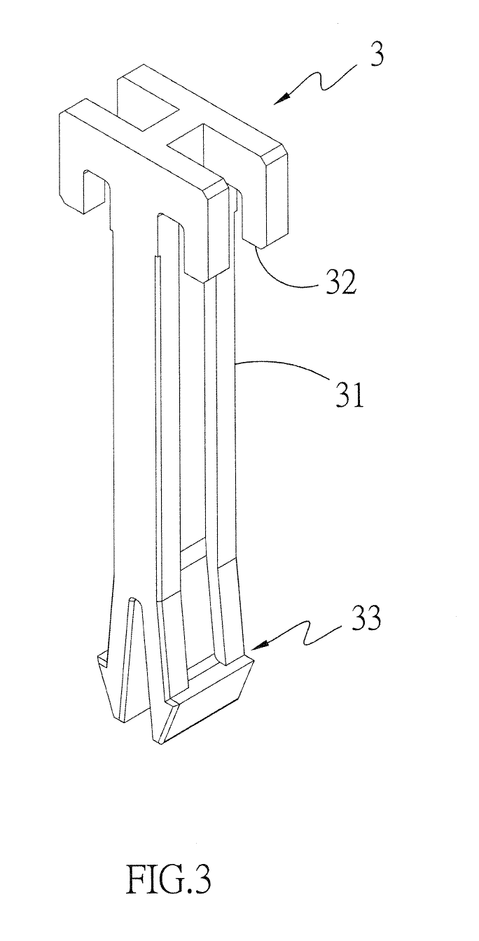

Referring to FIGS. 1-3, which are respectively a perspective view, an exploded view, and a partial schematic view of a preferred embodiment of the present invention, these drawings clearly show that the structure of connector combination according to the present invention comprises:

at least one first RJ45 connector 1, which has at least one side forming a first coupling section 11;

at least one second RJ45 connector 2, which has at least one side forming a second coupling section 21 that is jointable to the first coupling section 11; and

a positioning member 3, which fixes the first coupling section 11 and the second coupling section 21 together, the positioning member 3 comprising a bar 31 in which slide channels are formed, at least one fixing section 32 formed at one end of the bar 31, and a fastening section 33 at an end opposite to the fixing section 32.

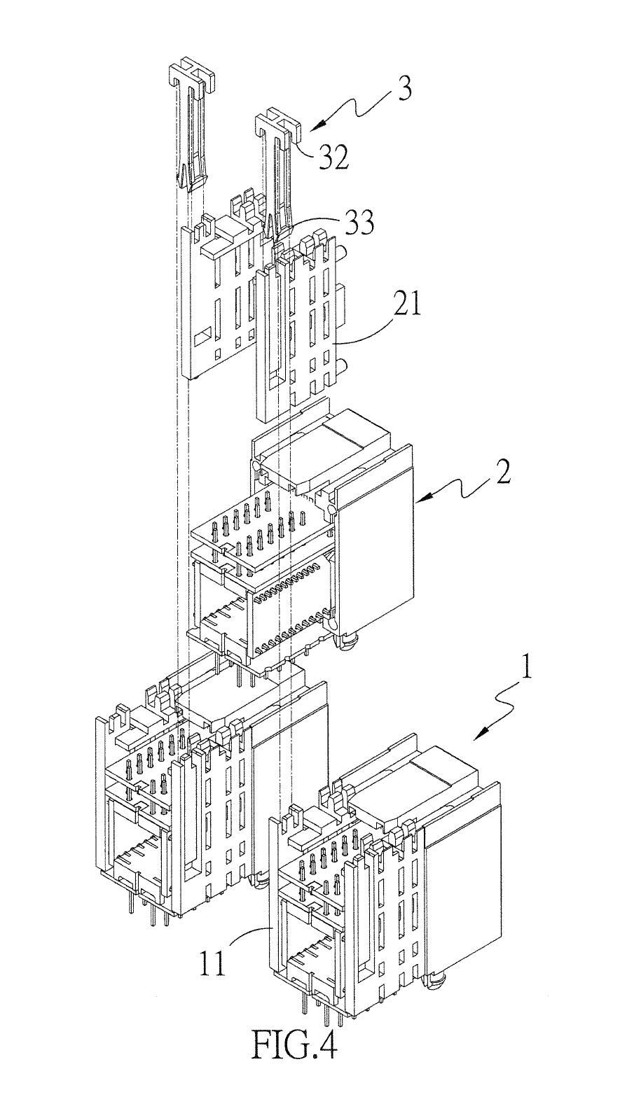

With the above structure and arrangement, an operation of use of the present invention will be described as follows, with reference to FIG. 4, which is a perspective view showing an example of using the preferred embodiment of the present invention, the thawing clearly shows that in the instant embodiment, explanation of the first coupling section 11 and the second coupling section 21 will be made with blocking plates being taken as an example, to combine the first RJ45 connectors 1 and the second RJ45 connectors 2, the site where the connectors are jointed to each other is arranged such that the blocking plates are respectively coupled to and fixed to the first RJ45 connector 1 and the second RJ45 connector 2 through a vertical movement. Under such a condition, the positioning member 3 is inserted, in a vertical direction from top to bottom, into and thus fixes the first coupling section 11 and the second coupling section 21 together. During the process of insertion, the fixing section 32 and the fastening section 33 of the positioning member 3 are moved into engagement with and thus further fixing the first coupling section 11 and the second coupling section 21 together. With such an arrangement of the positioning member 3 and the blocking plates of the first coupling section 11 and the second coupling section 21, connectors can be assembled and combined together according to the number desired by a customer. On the other hand, when the connectors get malfunctioning, it is possible to individually replace the broken ones of the connectors so as to achieve the advantages of efficient maintenance and repairing, reducing expense of replacement, reducing mold cost, and helping reducing the expense of customer's products.

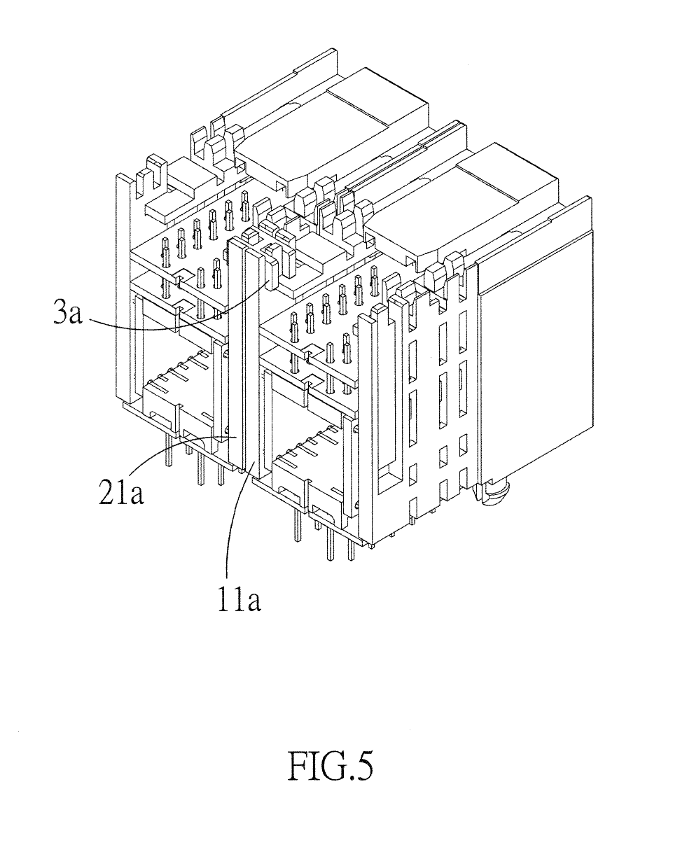

Referring to FIG. 5, which is a perspective view showing an example of using another preferred embodiment of the present invention, the drawing clearly shows that in the instant embodiment, the first coupling section 11a and the second coupling section 21a will be explained with a fastener being taken as an example, a difference from what described previously is that when the first coupling section 11a and the second coupling section 21a are move vertically for being assembled and combined, a fastener is first applied for initial fixing and then the positioning member 3a is used for positioning and fixing. The remaining operation will be identical to what described above so that repeated description will be omitted.

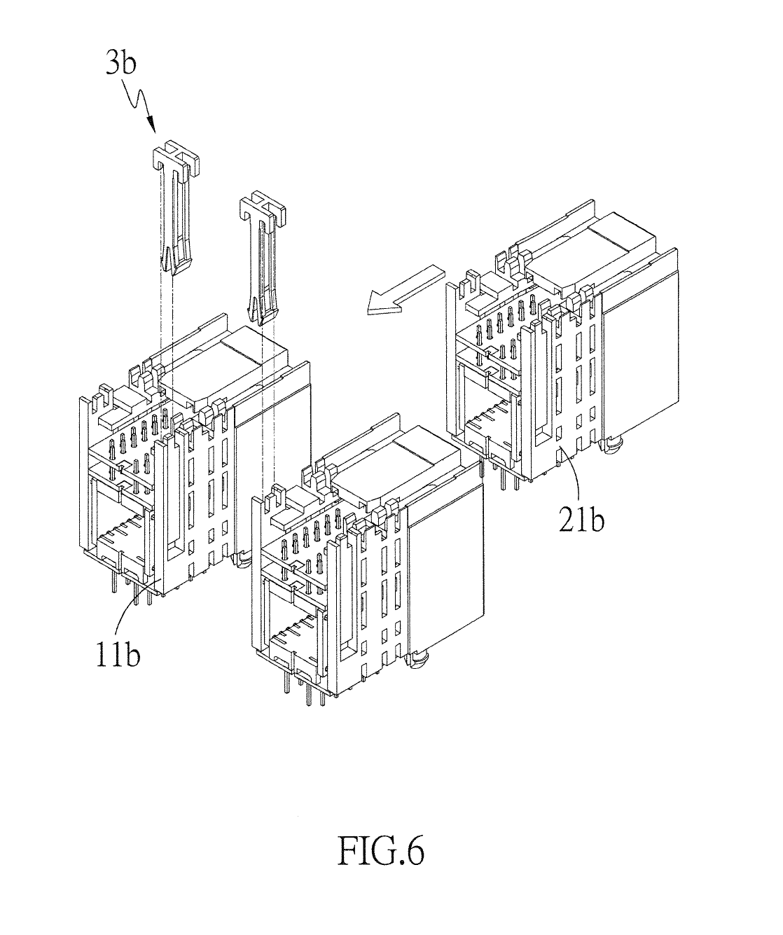

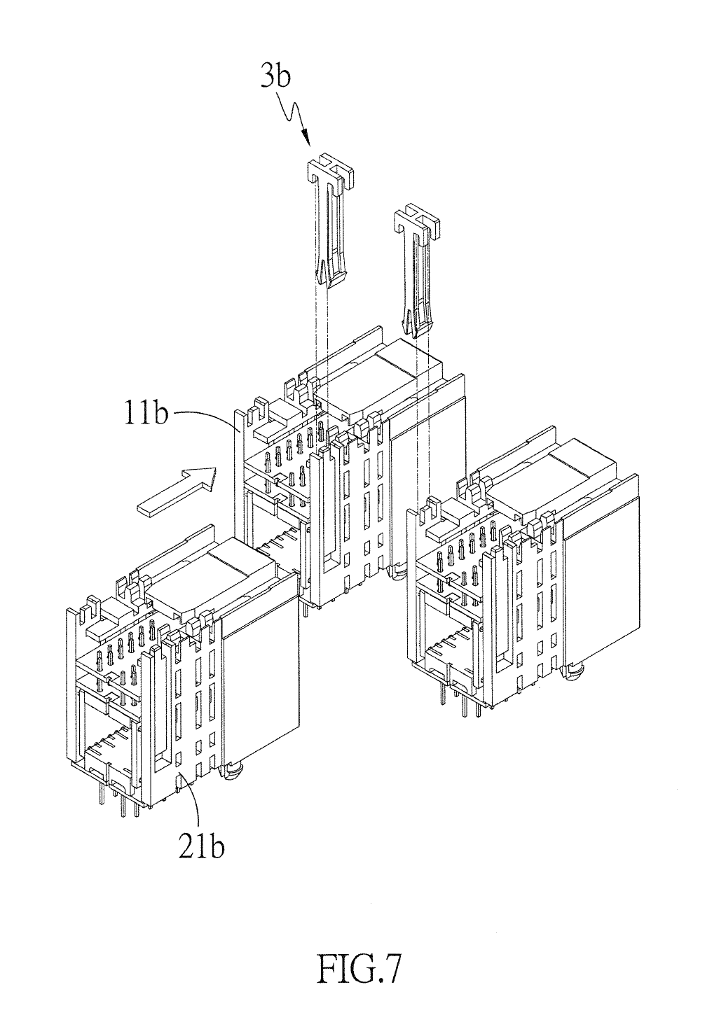

Referring to FIGS. 6 and 7, which are perspectives view showing an example of using a further preferred embodiment of the present invention, the drawings clearly show that in the instant embodiment, the first coupling section 11b and the second coupling section 21b will be explained with slide channels being taken as an example, a difference from what described previously is that when the first coupling section 11b and the second coupling section 21b are movement horizontally for being assembled and combined, a fastener is first applied for initial fixing and then the positioning member 3b is used for positioning and fixing. The remaining operation will be identical to what described above so that repeated description will be omitted.

Referring to all the drawings, compared to the known devices, the present invention shows the following advantages:

Using the positioning member 3 in combination with the first coupling section 11 and the second coupling section 12 makes it possible to make modifications according to the need of connector of a customer so as to achieve the advantages of efficient maintenance and reducing maintenance cost. Further, the present invention helps reducing the cost of making molds for the customer.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of a connector combination, comprising:
at least one first RJ45 connector, which has at least one side forming a first coupling section;
at least one second RJ45 connector, which has at least one side forming a second coupling section that is jointable to the first coupling section; and
a positioning member, which fixes the first coupling section and the second coupling section together.

2. The structure of the connector combination according to claim 1, wherein the first coupling section and the second coupling section are combined with each other through a vertical movement.

3. The structure of the connector combination according to claim 2, wherein the first coupling section and the second coupling section are blocking plates or fasteners.

4. The structure of the connector combination according to claim 1, wherein the first coupling section and the second coupling section are combined with each other through a horizontal movement.

5. The structure of the connector combination according to claim 4, wherein the first coupling section and the second coupling section are slide channels.

6. The structure of the connector combination according to claim 1, wherein the positioning member comprises:
a bar that forms slide channels;
at least one fixing section that is formed at one end of the bar; and
a fastening section that is set at an end opposite to the fixing section.
